(19) United States
(12) Patent Application Publication
(10) Pub. No.: US 2015/0026028 A1
(43) Pub. Date: Jan. 22, 2015

(54) Method for listing and trading a futures contract that has a daily mark to market against an index therefore allowing interest rate swaps to be substituted by constant maturity futures contracts.

(71) Applicants: James L. Davies, Aldbury (GB); Vijay A. Angelo, Mayfield (GB)

(72) Inventors: James L. Davies, Aldbury (GB); Vijay A. Angelo, Mayfield (GB)

(21) Appl. No.: 13/942,844

(22) Filed: Jul. 16, 2013

(51) Int. Cl. G06Q 40/04

(52) U.S. Cl. CPC G06Q 40/04
USPC 705/37

(57) ABSTRACT

A method for trading an index based on a notional contract using a futures contract where the futures contract is marked to the value of the index on a daily basis rather than only on expiry of the future. In one aspect of the invention the futures contract can be further adapted to have no expiry date, and the mark-to-market used to tie the contract to the underlying market. This construction is particularly useful when trading interest rate products, where the interest rate sensitivity of the International Money Market Dates for expiry changes the nature of the hedge.

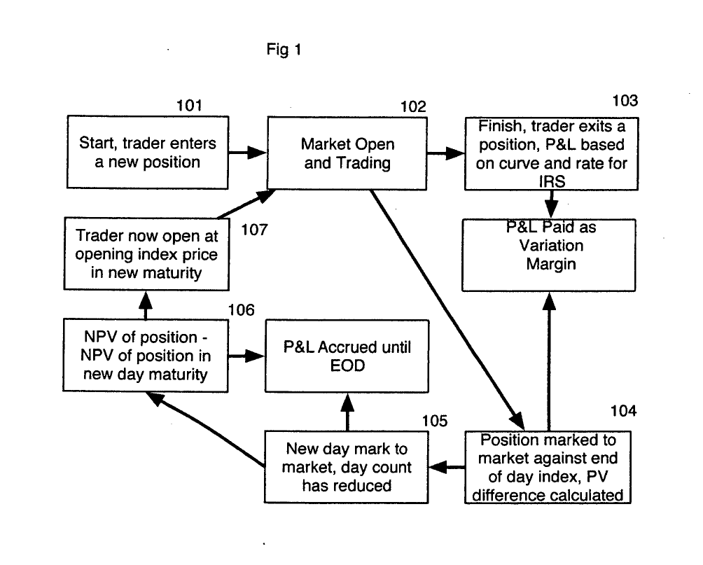

### TECHNICAL FIELD OF THE INVENTION

The present invention relates to financial derivatives and computer systems and computer-implemented methods for facilitating trading of financial derivatives. In some embodiments, the present invention relates to methods and apparatus for listing and trading improved swap futures contracts.

### BACKGROUND OF THE INVENTION

There are a wide variety of financial derivatives products currently available to the market. In general, a financial derivative is a contract or financial product whose economic value can be derived from one or more other financial products.

One type of financial derivative is a financial futures contract such as a stock market index futures contract. Typically stock market futures contracts require cash settlement on a specific expiration date in an amount referenced on the stock market index. “FTSE futures” are one example of a stock market futures contract, and use the FTSE 100 Index as the reference index. Similarly other futures expire into other instruments, Treasury Futures, such as the Bund, expire requiring the short to deliver to the long a bond from a specified basket of bonds, Copper Futures expire requiring short to deliver a warehouse receipt from an approved warehouse for specified quantity of copper, and some expire to deliver another type of derivatives contract, such as options on futures or the CME/Goldman Physically delivered Swap future that expires to require the short and long to take either sides of a swap.

One specific type of financial derivative is referred to as a “swap”. In the most generic sense this is simply an exchange of cash flows between two counterparties. One type of swap is referred to as an “interest rate swap”. In one variety of interest rate swap, one counterparty agrees to make fixed payments of interest to the other counterparty over a period of time (for example, 10 years) on a notional amount of principal. The second counterparty agrees to make payments to the first counterparty that fluctuate over the period of time in accordance with fluctuations in a “floating” interest rate (such as the LIBOR (London Interbank Offered Rate) 3 month rate) for the same notional principle. This type of interest rate swap is referred to as a fixed/floating interest rate swap. In market convention when someone refers to an interest rate swap without other clarification it is usually assumed that they are referring to a fixed/floating interest rate swap. The period of time during which the swap is effective may be referred to as its Maturity. The party that receives the fixed side of the interest rate swap may do so in order to hedge against future interest rate fluctuations. Interest rate swaps and other swaps may also be employed as part of financial strategies that are much more complex than simple hedging or speculation.

The market has traded swaps for a relatively short period, as recently as 1981, the first interest rate swap was traded. At the time the World Bank and IBM had a problem. During this period interest rates in the United States were very high; the World Bank needed to borrow money, but at a lower rate. IBM had debt to pay in Swiss Francs and Deutsche Marks. The interest rate in Switzerland was far less than the US interest rate. So IBM and the World Bank worked out an arrangement where the World Bank borrowed US dollars and they “swapped” the dollar debt to IBM for IBM's Swiss franc and Deutsche mark debt. This is now referred to as a cross currency interest rate swap.

The swap market was scant in volume before 1985, as the 80's progressed swap transactions started to grow as issuers and investors found they could lower their costs of financing or raise the yield on bold investments, by exploiting comparative advantage and arbitrage via swap transaction.

Originally, the banks and other financial institutions were acting as middlemen between counter-parties of the swap, pocketing huge commissions. However as the swap markets grew the financial institutions started to risk manage their interest rate and currency exposure, using the flexibility of swaps. To handle this banks started to take positions in the market, facilitating liquidity and trading versus the view that they have on the marketplace, a large portion of this derived from the flow that they have.

This market has seen few major innovations since inception, and today the majority of the market in greater than 500 trillion USD of notional IRS for both long term hedging and short term hedging of exposures to the interest rate curve is still handed through the Interest Swap Market. The marketplace has grown since 1981, into arguably the second biggest market in the world after foreign exchange, it is now a mixture of bi-laterally arranged deals, and a brokered market place. However the contracts for the exposure have not evolved greatly, in fact an entire industry centered around contracts provided by the bank owned International Swaps and Derivatives Association (ISDA) has arisen to service the status quo, creating a high bar to change and innovation in this industry.

In the aftermath of the 2007-8 financial crisis there has been increased political pressure on the financial markets to change trading methodologies to more transparent, and utilize more open methods. There has further been increased political pressure to put all trading through transparent marketplaces allowing the measurement and control of this activity. Further there has been increased political pressure, and a mandate from the G20 to replace counterpart to counterpart trading with central counterparty trading as much as possible.

This has led to explicit movement to trade contracts known as swaps with contracts that have more in common with futures than swaps.

There have been a number of efforts over the last decade by the futures exchanges to bring swap trades, and more properly hedging of the change in the floating rate or the present value change of the fixed leg component of a swap to the futures markets. None of these efforts have gained any significant traction; primarily this has failed because they have not embodied the design of their futures contracts with the appropriate exposure to the interest rate, thus making the constant adjustment of the number of contracts for the hedge necessary, thus inflating the cost of the hedge substantially.

Specifically these have focused on the delivery or cash settlement of futures against a nominal swap with a known coupon, at a specific date fixed in the future. The trader then trades the cost of trading this at some point in the future as a proxy for exposure to the change in value of a swap struck today. However as the two components of interest rate do not align precisely the contract is more expensive to trade than other possible constructions.

A more appropriate construction of an interest rate swap future is possible, that gives the same convexity, that is change in present value relative to change in rate, as an interest rate of the same maturity.

### SUMMARY OF THE INVENTION

Traditional futures contracts are based on a specified settlement date at some point in the future, the purpose being to produce price convergence between the futures price and the price of the underlying contract. This construction guarantees the holder of the contract that the price they struck the contract at today, plus the flow of variation margin between today and the expiry date will equal the cost of the underlying contract on that day. These are used when the trader wishes to have exposure to the price of an asset at a particular point in time, and the primary concern is having the available capital in place to purchase it.

Futures on Swaps that currently exist (Swapnotes), both physically delivered and financially settled face a number of issue, principally, that the relative value of the nominal interest rate swap at the point of settlement is always changing, and not just with a linear relationship to the change in current market interest rates. This arises as the interest rate swap is itself a derivative, and therefore a derivative on a derivative is likely to have more issues arise.

We assert that the commodity that the market is interested in being exposed to is the rate at a specific maturity, i.e. what is the rate in the market on a specific maturity that the market considers to be fair value. This has many names, some are slight variations, the yield curve, the swap curve, the discount curve, the swap rate. All of these are measured by looking at the current price available in the market for a fixed/floating interest rate swap at the maturity.

Therefore we examine the need to give exposure to a curve of derivative prices or similar constructions. It occurs that as the value in any point on the curve is not just the curve, but the whole curve up to the point of the maturity; or the shape of the curve to the maturity, that it is therefore not a fair representation of the desired exposure to measure the value of an off-curve nominal swap and how this changes over time to produce the value of the swap.

It further that the futures component that is a date in the future affects the pricing of a swap by adding the cost of overnight flows to support the buying of the swap at a future point. Some effort has been made through relatively complex structures to remove this from the future. In general this has been called price alignment interest. The addition of this has caused as many issues in the modeling as it has solved.

We therefore propose and describe a new type of future, a constant maturity future, based on an index, a constant maturity index. Importantly this future varies primarily in the construction of the end of day and overnight processes. This future marks-to-market every night against the price value of the underlying market, rather than a closing price of the future as is the case futures markets. This makes price convergence happen on a nightly basis rather than only on an expiry date, and means that cash flows reflect those in the underlying marketplace. We leave the rest of the construction of the future intact, requiring Central Counterparties, Clearing Members, market abuse rules, and all the normal trappings of a futures contract that guarantee members a fair market.

We further propose and describe a constant maturity index, a methodology for producing an index which gives the market value of every contract in a given maturity. Here when used for an interest rate swap, a mid-price (between bid and offer) can be generated from interest rate swap market bid-offer prices weighted by size and sentiment prices from appropriate market contributors. This allows the publication, in real-time, of a mid-price for each maturity on the swap curve in a given currency. This constant maturity index can then for the basis for the end of day mark-to-market.

This constant maturity index has further utility in assisting the production of constant maturity futures in other over the counter (OTC) products. Where the contract in normally traded as a given maturity, and there are underlying contract with predictable sensitivity to interest rates, a duration modification can be applied to these instruments to synthetically give them the appropriate maturity, allowing the creation of a constant maturity index, and thus a constant maturity future. Non-deliverable forward foreign exchange is a good example, this is normally traded with a 30 day maturity, but occasionally varies because of holidays. This can be normalized with a constant maturity future.

The constant maturity future then gives a utility that the underlying swap market doesn't. In a normal swap (or forward market), there is a liquid market in the maturity, but not in the contracts struck on previous days, plus with bi-lateral credit, unwinding exposure is nearly impossible. In modern times with central counterparty exposure of the swaps, the unwinding is still not possible due to the complexity in offsetting trades. The constant maturity future as a standardized instrument, i.e. one that marks-to-market every day based on an index price, solves this problem.

There is a further specialization of the constant maturity future possible when applied to interest rate swap market. That is a dynamic tick size. This is introduced to allow the trader to trade the rate at a specific maturity, but still give exposure to the market akin to an interest rate swap. The important part of trading an interest rate swap market is the discount curve from the constant maturity index. Here we have to do away with another standard futures concept that is a fixed tick size. Instead for each trade we calculate the present value of the fixed leg at the maturity traded, based on the rate traded. Thus the trader trades the rate, but the trade is valued intra-day using the present value of the fixed leg equivalent of a notional swap struck at that maturity with that rate. Here we use standard discount factors generated from the constant maturity index, along with any necessary short dated lending rate, i.e. 1 year OIS, to calculate the present value, thus further tying the contract to the underlying market. Any positions then held at the end of the day are marked-to-market using the end of day price or equivalent construction from the constant maturity index to select the rate. This is then turned into a present value, and all trades made are compared to this present value to work out their P&L. Mathematically equivalent processes that calculate this during the trading day are also possible.

Keeping a product constant in maturity when you are trading a constant maturity future based on a constant maturity index of interest rate swap requires a number of other constructs, as the index easily tracks changes overnight when the day count, moves, it is less easy with the future, where the expectation is that the maturity is maintained, but the contract also be exposed to overnight economic moves. Here we introduce the concept of an overnight constancy process after the daily mark-to-market.

This process involves making the P&L a true reflection of the underlying market value changes but the adjusting to keep maturity constant. In one variation, applicable to vanilla interest rate swaps, the process involves, exchanging a cash flow between the long and short position holder to represent any accrual value in the net present value of the swap. Secondly a mark-to-market is performed at the open the following morning, to represent the effect of the overnight economic movement on the whole curve. This is performed by using an interpolation to calculate the fair value rate on the curve of the overnight (or indeed weekend or holidays) change in the day count. A cash flow is then exchanged between the long and the short position holder to represent any change in the economic value of the maturity held on the previous day, this is generated by the present value of the new day minus the present value of the prior day. Finally the net present value of this swap is calculated, as well as the net present value of the swap on the full maturity and cash flows are exchanged equivalent to tearing up one swap and opening up another between the same counterparties at the market mid rates.

### Diagrams

The diagram shows the operating process of the CMF contract for an interest rate swap example. Here the trader enters a new trade [101], and the market is open to trade for all participants [102], a trader may decide to exit a position on the same day, and in so doing realize a P&L [103], this P&L being the difference in the present value of the fixed leg of the swap at time of entry from time of exit, where the present value is calculated using the rate transacted, and a constant maturity index to discount all the payments of the equivalent swap to today. Should the trader choose not to close out the trade but to hold the position overnight, at the end of the day the constant maturity future is marked-to-market [104], and difference in Present Value from the entry price of a trader is calculated and P&L paid. The next morning a new mark-to-market happened for the previous days position with the same maturity date as was held on the previous trading day [105]. This happens using the exchanges choice of interpolation. Next the Net present value of the previous day swap and the net present value of a new day swap at the index price for that maturity are calculated, and P&L paid [106], this is the equivalent of tearing up a swap and opening up a new swap at the new maturity. The trader now has a constant maturity future again and may begin trading once more [107]

What is claimed is:

1. A processor implemented method of operating an exchange, the method comprising: listing via a processor a futures contract, said futures contract including terms that mark the value of the position against an index at the end of day each trading day in the contract on a daily basis, wherein: (a) said futures contract provides that (i) a long position holder in said futures contract entitles the holder to receive profit or pay loss versus the mark-to-market value versus an underlying index on the daily basis where such profit or loss is the difference between the holders entry price, or most recent mark-to-market price and the next mark-to-market price from the underlying index. An increase in the value of the index corresponds to a profit to the holder. (ii) a short position holder in said futures contract entitles the holder to receive profit or pay loss versus the mark-to-market value versus an underlying index on a daily basis where such profit or loss is the difference between the holders entry price, or most recent mark-to-market price and this mark-to-market price from the underlying index. A decrease in the value of the index corresponds to a profit to the holder; and transmitting said data from the computer system.

2. The method of claim 1, wherein the relative profit and loss between the holders of the long and short position relative to the underlying index is reversed.

3. The method of claim 1, wherein the underlying index is a proxy for a more complex calculation, such as a traded rate which represents the present value of a leg of a swap.

4. The method of claim 1, wherein the underlying index is a proxy for a more complex calculation, such as a strip of forward rate agreement contracts.

5. The method of claim 1, wherein the futures contract has no expiry date, a Constant Maturity Future, and is open to trade in perpetuity having no expiry date, but being marked-to-market against an index on a daily basis.

6. The method of claim 1, wherein the index that the futures contract is marked against is a Constant Maturity Index, where the index is constructed from traded prices, bid/offer prices or mid-price sentiment derived prices of a specific maturity of an interest rate swap.

7. The method of claim 6, wherein the index that the constant maturity index that the contract is marked to is based solely on instruments that have the maturity specified in that index. Each day the maturity is kept constant and the uses the reference market rather than fixing to specific instruments.

8. The method of claim 6, wherein the index that the constant maturity index that the contract is marked to is based on instruments where an adjustment is applied to their price to give them effectively the same maturity as the index requires.

9. The method of claim 1, wherein the futures contract has a specific mechanism that is applied to the overnight process that applies at the close and the open of the contract to reflect the value of keeping the contract constant in maturity.

10. The method of claim 9, wherein the futures contract overnight mechanism includes an accrual payment between the holder of the long position and the holder of the short position that is represented by the equivalent of a single days accrual of an equivalent swap at the same rate and maturity of the swap price at the point of the mark-to-market.

11. The method of claim 9, wherein the futures contract is marked-to-market at the open against a point on an exponential curve of swap rates derived from a constant maturity index which represents the maturity minus difference in the day count from the previous trading day to the trading day on the open of the new day's trading.

12. The method of claim 9, wherein on the open of a trading day, there is an exchange in the net present value of the equivalent swap between the holders of the long position in the futures contract and the holders of the short positions in the futures contract using the both the current day open price, and an exchange in the net present value of the equivalent swap between the holders of the long position in the futures contract and the holders of the short positions in the futures contract using the mark-to-market price using a point on an Exponential Interpolation to build a curve of swap rates derived from a series of constant maturity indices where the point represents the maturity minus difference in the day count from the previous trading day to the trading day on the open of the new day's trading.

13. The method of claim 6 wherein the market that the prices for instruments are taken from and used to construct the constant maturity index are Interest Rate Swaps.

14. The method of claim 8 wherein the underlying market for the construction of the Constant Maturity Index is the Non-Delivered Forward FX market.

15. The method of claim 6 wherein the market that the prices for instruments are taken from and used to construct the constant maturity index are Cross-Currency Swaps.

16. The method of claim 8 wherein the underlying market for the construction of the Constant Maturity Index is the Overnight Index Swaps.

17. The method of claim 6 wherein the market that the prices for instruments are taken from and used to construct the constant maturity index are Inflation Swaps.

18. The method of claim 6 wherein the market that the prices for instruments are taken from and used to construct the constant maturity index are Asset Swap Spread.

19. The method of claim 6 wherein the market that the prices for instruments are taken from and used to construct the constant maturity index are Matched Maturity Asset Swap Spread.

20. The method of claim 6 wherein the market that the prices for instruments are taken from and used to construct the constant maturity index are Credit Default Swaps.

21. The method of claim 8 wherein the market that the prices for instruments are taken from and used to construct the constant maturity index are Sovereign Debt Instruments.

22. The method of claim 6 wherein the market that the prices for instruments are taken from and used to construct the constant maturity index are Total Return Swaps.

23. The method of claim 6 wherein the market that the prices for instruments are taken from and used to construct the constant maturity index are Mortality Swaps.

24. The method of claim 8 wherein the market that the prices for instruments are taken from and used to construct the constant maturity index are baskets of Repo Instruments.

25. The method of claim 12 wherein the exponential interpolation is replaced with a Cubic Spline Interpolation.

26. The method of claim 12 wherein the exponential interpolation is replaced with a Linear Interpolation.

27. The method of claim 1 wherein the tick value of the futures contract is a fixed value based on a subdivision of the notional size of the contract.

28. The method of claim 1 wherein the tick value of the futures contract is a dynamic value based on a the present value of a leg of a notional swap discounted to current present value by a series of constant maturity swap indices and where appropriate the Overnight Interbank Swap Rate, or equivalent replacement short term lending rate.

29. The method of claim 1 wherein the tick value of the futures contract is a dynamic value based on a the net present value of a notional swap discounted to current present value by a series of constant maturity swap indices and where appropriate the Overnight Interbank Swap Rate, or equivalent replacement short term lending rate.

30. The method of claim 1 wherein the tick value of the futures contract is a dynamic value based on a the present value of a an underlying debt instrument discounted to current present value by a series of constant maturity swap indices and where appropriate the Overnight Interbank Swap Rate, or equivalent replacement short term lending rate.

31. The method of claim 28 wherein the traded quantity is the notional rate of the equivalent swap and the executed trade confirmation is for the present value of one leg of the equivalent swap.

32. The method of claim 29 wherein the relative profit and loss between the holders of the long futures position and the short futures position is the difference between the present value of the trades at point of execution, multiplied by the number of contracts traded and the notional contract size.

33. A processor implemented method comprising: holding via a processor a position in a Constant Maturity Futures contract, said Constant Maturity Futures contract including . terms that represent the underlying notional instrument, and require the end of day mar-to-market of the Constant Maturity Index against a specified constant maturity index.

34. The method of claim 33, further comprising: storing a record of the position in a computer.

35. The method of claim 33, further comprising: storing, in the computer, a record of a position in the equivalent underlying contract.

36. The method of claim 5, further comprising: a market rule existing allowing the temporary addition of an expiry date based on exceptional market circumstances such as illiquidity.

37. The method of claim 44, further comprising storing a present value of a transaction entered into based on the discount factors of a constant maturity index.
